(19) United States
(12) Patent Application Publication
(10) Pub. No.: US 2023/0036214 A1
(43) Pub. Date: Feb. 2, 2023

(54) NON-ORIENTED ELECTRICAL STEEL SHEET AND MANUFACTURING METHOD THEREFOR

(71) Applicant: POSCO, Pohang-si, Gyeongsangbuk-do (KR)

(72) Inventors: Jaewan Hong, Pohang-si, Gyeongsangbuk-do (KR); Junesoo Park, Pohang-si, Gyeongsangbuk-do (KR)

(73) Assignee: POSCO, Pohang-si, Gyeongsangbuk-do (KR)

(21) Appl. No.: 17/784,407

(22) PCT Filed: Dec. 17, 2020
(86) PCT No.: PCT/KR2020/018610

§ 371 Date: Jul. 21, 2022

(30) Foreign Application Priority Data
Dec. 19, 2019 (KR) 10-2019-0171284

(51) Int. Cl. C21D 9/46; C22C 38/14; C22C 38/06; C22C 38/04; C22C 38/02; C22C 38/00; C21D 8/12; C21D 8/00; C21D 6/00; H01F 1/147; B21B 1/24

(52) U.S. Cl. CPC C21D 9/46; C22C 38/14; C22C 38/06; C22C 38/04; C22C 38/02; C22C 38/008; C22C 38/002; C22C 38/001; C21D 8/1222; C21D 8/1233; C21D 8/1272; C21D 8/005; C21D 6/008; C21D 6/005; H01F 1/14775; B21B 1/24; C22C 2202/02

(57) ABSTRACT

A non-oriented electrical steel sheet according to an embodiment of the present invention includes, in wt %, Si: 2.1 to 3.8%, Mn: 0.001 to 0.6%, Al: 0.001 to 0.6%, Bi: 0.0005 to 0.003%, and Ge: 0.0003 to 0.001%, and the balance of Fe and inevitable impurities.

### TECHNICAL FIELD

An embodiment of the present invention relates to a non-oriented electrical steel sheet and a manufacturing method therefor. More specifically, an embodiment of the present invention relates to a non-oriented electrical steel sheet with excellent magnetic flux density and iron loss by adding Bi and Ge to selectively form and control precipitates to improve texture thereof, and a manufacturing method therefor.

### BACKGROUND ART

An electrical steel sheet is a product used as a material for a transformer, a motor, and an electric machine, and unlike a general carbon steel that places importance on processability such as mechanical properties, it is a functional product that places importance on electrical properties. Required electric properties include low iron loss, high magnetic flux density, high magnetic permeability, and height stacking factor. The electrical steel sheet is classified into a grain-oriented electrical steel sheets and a non-oriented electrical steel sheet. The grain-oriented electrical steel sheet has excellent magnetic properties in a rolling direction by forming a Goss texture ({110}<001>texture) on an entire steel sheet by using an abnormal grain growth phenomenon called secondary recrystallization. The non-oriented electrical steel sheet is an electrical steel sheet with uniform magnetic properties in all directions on a rolled sheet. In a production process of the non-oriented electrical steel sheet, a slab is manufactured, and then hot-rolled, cold-rolled, and final-annealed to form an insulating coating layer. In a production process for a grain-oriented electrical steel sheet, a slab is manufactured, and then hot-rolled, preliminary-annealed, cold-rolled, decarburization-annealed, and final-annealed to form an insulating coating layer. Among them, the non-oriented electrical steel sheet has uniform magnetic properties in all orientations, so it is generally used as a material for a motor core, a generator iron core, a motor, and a small transformer. Typical magnetic properties of the non-oriented electrical steel are iron loss and magnetic flux density, and the lower the iron loss of the non-oriented electrical steel sheet, the less iron loss occurs in a process of magnetizing an iron core, thereby improving efficiency, and since the higher the magnetic flux density, the larger a magnetic field may be induced with the same energy, and since less current may be applied to obtain the same magnetic flux density, energy efficiency may be improved by reducing copper loss. A typically used method for increasing the magnetic properties of the non-oriented electrical steel sheet is to add an alloying element such as Si. The addition of the alloying element can increase specific resistance of the steel, and as the specific resistance is higher, eddy current loss decreases, thereby reducing the total iron loss. On the contrary, as the content of Si increases, the magnetic flux density is deteriorated and brittleness increases, and when more than a predetermined amount thereof is added, it may not be cold rolled and may not be able to be commercially produced. Particularly, the electrical steel sheet may obtain the effect of reducing the iron loss as it becomes thinner, but the deterioration of rolling by the brittleness is a serious problem. Elements such as Al and Mn are added to further increase the specific resistance of the steel to produce the highest grade non-oriented electrical steel sheet with excellent magnetic properties. However, in actual use of the motor, iron loss and magnetic flux density are required at the same time depending on application, so a non-oriented electrical steel sheet with high specific resistance and low iron loss and high magnetic flux density is required.

### DISCLOSURE

### DESCRIPTION OF THE DRAWINGS

### Technical Problem

An embodiment of the present invention provides a non-oriented electrical steel sheet and a manufacturing method therefor. More specifically, an embodiment of the present invention provides a non-oriented electrical steel sheet with excellent magnetic flux density and iron loss by adding Bi and Ge to selectively form and control precipitates to improve texture thereof, and a manufacturing method therefor.

### Technical Solution

A non-oriented electrical steel sheet according to an embodiment of the present invention includes, in wt %, Si: 2.1 to 3.8%, Mn: 0.001 to 0.6%, Al: 0.001 to 0.6%, Bi: 0.0005 to 0.003%, and Ge: 0.0003 to 0.001%, and the balance of Fe and inevitable impurities.

The non-oriented electrical steel sheet may further include one or more of P: 0.08 wt % or less, Sn: 0.08 wt % or less, and Sb: 0.08 wt % or less.

The non-oriented electrical steel sheet may further include one or more of C: 0.01 wt % or less, S: 0.01 wt % or less, N: 0.01 wt % or less, and Ti: 0.005 wt % or less.

One or more of Cu, Ni, and Cr may be further included in an amount of 0.05 wt % or less, respectively.

One or more of Zr, Mo, and V may further be included in an amount of 0.01 wt % or less, respectively.

When an EBSD test is performed on a 1/6 to 1/4 region of a thickness of the steel sheet, a strength of a {111} plane facing a <112>direction based on a rolling direction on an ODF may be 2 or less compared to a random orientation.

In a region of 1/6 to 1/4 of a thickness of the steel sheet, a ratio (V{100}/V{411}) of a fraction (V{100}) of texture in which a {100} plane of the texture and a rolling plane are parallel within a 15° angle with respect to a fraction (V{411}) of the texture in which a {411} plane of the texture and the rolling plane are parallel within a 15° angle, may be 0.150 to 0.450.

In the region of 1/6 to 1/4 of the thickness of the steel sheet, a ratio (V{100}/V{411}) of a fraction (V{100}) of the texture in which the {100} plane of the texture and the rolling plane are parallel within a 10° angle with respect to a fraction (V{411}) of the texture in which the {411} plane of the texture and the rolling plane are parallel within a 10° angle, may be 0.350 to 0.550.

In the region of 1/6 to 1/4 of the thickness of the steel sheet, a ratio (V{100}/V{411}) of a fraction (V{100}) of the texture in which the {100} plane of the texture and the rolling plane are parallel within a 5° angle with respect to a fraction (V{411}) of the texture in which the {411} plane of the texture and the rolling plane are parallel within a 5° angle, may be 0.450 to 0.650.

Another embodiment of the present invention provides a manufacturing method of a non-oriented electrical steel sheet, including: hot-rolling a slab that includes, in wt %, Si: 2.1 to 3.8%, Mn: 0.001 to 0.6%, Al: 0.001 to 0.6%, Bi: 0.0005 to 0.003%, and Ge: 0.0003 to 0.001%, the balance of Fe, and inevitable impurities to manufacture a hot-rolled sheet; cold-rolling the hot-rolled sheet to manufacture a cold-rolled sheet; and final annealing the cold-rolled sheet.

The manufacturing method of the non-oriented electrical steel sheet may further include, after the manufacturing of the hot-rolled sheet, annealing the hot-rolled sheet at a temperature of 900 to 1195° C. for 30 to 95 seconds.

The final annealing may be performed at a temperature of 850 to 1080° C. for 60 to 150 seconds.

### Advantageous Effects

According to the embodiment of the present invention, it is possible to provide a non-oriented electrical steel sheet having an improved texture and excellent iron loss and magnetic flux density.

### Mode for Invention

It will be understood that, although the terms first, second, third, etc. may be used herein to describe various elements, components, regions, areas, zones, layers, and/or sections, they are not limited thereto. These terms are only used to distinguish one element, component, region, area, zone, layer, or section from another element, component, region, layer, or section. Therefore, a first part, component, region, area, zone, layer, or section to be described below may be referred to as second part, component, area, layer, or section within the range of the present invention.

The technical terms used herein are to simply mention a particular embodiment and are not meant to limit the present invention. An expression used in the singular encompasses an expression of the plural, unless it has a clearly different meaning in the context. In the specification, it is to be understood that the terms such as “including”, “having”, etc., are intended to indicate the existence of specific features, regions, numbers, stages, operations, elements, components, and/or combinations thereof disclosed in the specification, and are not intended to preclude the possibility that one or more other features, regions, numbers, stages, operations, elements, components, and/or combinations thereof may exist or may be added.

When referring to a part as being “on” or “above” another part, it may be positioned directly on or above the other part, or another part may be interposed therebetween. In contrast, when referring to a part being “directly above” another part, no other part is interposed therebetween.

Unless otherwise stated, % means wt %, and 1 ppm is 0.0001 wt %. In embodiments of the present invention, inclusion of an additional element means replacing the balance of iron (Fe) by an additional amount of the additional elements.

Unless otherwise defined, all terms used herein, including technical or scientific terms, have the same meanings as those generally understood by those with ordinary knowledge in the field of art to which the present invention belongs. Terms defined in commonly used dictionaries are further interpreted as having meanings consistent with the relevant technical literature and the present disclosure, and are not to be construed as having idealized or very formal meanings unless defined otherwise.

The present invention will be described more fully hereinafter with reference to the accompanying drawings, in which embodiments of the invention are shown. As those skilled in the art would realize, the described embodiments may be modified in various different ways, all without departing from the spirit or scope of the present invention.

A non-oriented electrical steel sheet according to an embodiment of the present invention includes: in wt %, Si: 2.1 to 3.8%, Mn: 0.001 to 0.6%, Al: 0.001 to 0.6%, Bi: 0.0005 to 0.003%, and Ge: 0.0003 to 0.001%, and the balance of Fe and inevitable impurities.

Hereinafter, the reason for limiting the components of the non-oriented electrical steel sheet will be described.

Si: 2.10 to 3.80 wt %

Silicon (Si) is a major element added to reduce eddy current loss of iron loss by increasing specific resistance of steel. When too little Si is added, iron loss is deteriorated. Conversely, when too much Si is added, a magnetic flux density is largely reduced, and a problem may occur in processability. Accordingly, Si may be included in the above-mentioned range. Specifically, Si may be included in an amount of 2.50 to 3.70 wt %. More specifically, Si may be included in an amount of 2.60 to 3.50 wt %.

Mn: 0.001 to 0.600 wt %

Manganese (Mn) is an element that lowers iron loss by increasing specific resistance along with Si and Al, and that improves texture. When too little Mn is added, sulfides may be finely precipitated to deteriorate magnetism. Conversely, when too much Mn is added, formation of a {111} texture unfavorable to magnetism is promoted, so that the magnetic flux density may decrease. Therefore, Mn may be included in the above-mentioned range. Specifically, Mn may be included in an amount of 0.005 to 0.59 wt %. Specifically, Mn may be included in an amount of 0.01 to 0.57 wt %.

Al: 0.001 to 0.600 wt %

Aluminum (Al) plays an important role in reducing iron loss by increasing specific resistance together with Si, and also improves rollability or workability during cold rolling. When too little Al is added, it has no effect on reducing the high frequency iron loss, and the precipitation temperature of AIN is lowered, so that the nitride is finely formed, thereby reducing the magnetism. When too much Al is added, the nitride is excessively formed, deteriorating the magnetism, and causing problems in all processes such as steel making and continuous casting, which may considerably reduce productivity. Accordingly, Al may be included in the above-mentioned range. Specifically, Al may be included in an amount of 0.005 to 0.590 wt %. More specifically, Al may be included in an amount of 0.010 to 0.580 wt %.

Bi: 0.0005 to 0.0030 wt %

Bismuth (Bi) is a segregation element and degrades strength of a grain boundary by segregation at the grain boundary, and inhibits a phenomenon that a potential is fixed to the grain boundary. Through this, it is possible to contribute to controlling the precipitates by reducing the conditions capable of forming the precipitates. When too little Bi is included, it is difficult to expect the above-described role. When Bi is included in an excessive amount, it may rather deteriorate the magnetism. Accordingly, Bi may be included in the above-mentioned range. Specifically, Bi may be included in an amount of 0.0010 to 0.0025 wt %.

Ge: 0.0003 to 0.0010 wt %

Germanium (Ge), like Bi, as a segregation element, also contributes to control of the precipitates because it affects the behavior of S-, C-, and N-based precipitates even when only a trace amount is added. When too little Ge is included, it is difficult to expect the above-described role. When Ge is included in an excessive amount, it may rather deteriorate the magnetism. Accordingly, Ge may be included in the above-mentioned range. Specifically, Ge may be included in an amount of 0.0005 to 0.0010 wt %.

The non-oriented electrical steel sheet according to the embodiment of the present invention may further include one or more of P: 0.08 wt % or less, Sn: 0.08 wt % or less, and Sb: 0.08 wt % or less. As described above, when the additional elements are further contained, they replace the balance Fe.

P: 0.080 wt % or less

Phosphorus (P) not only serves to increase the specific resistance of the material, but also is segregated at the grain boundary to improve the texture to increase the specific resistance and decrease the iron loss, so it may be additionally added. However, when an addition amount of P is too large, it may cause the formation of a texture unfavorable to magnetism, and thus may have no effect of improving the texture, and excessive segregation at the grain boundary may reduce rollability and workability, thereby making production difficult. Accordingly, P may be added in the above-mentioned range. Specifically, P may be included in an amount of 0.001 to 0.080 wt %. More specifically, P may be included in an amount of 0.001 to 0.030 wt %.

Sn: 0.08 wt % or less

Tin (Sn) is segregated at the grain boundaries and the surfaces to improve the texture of the material and inhibit surface oxidation, and thus may be additionally added to improve the magnetism. When too much Sn is added, grain boundary segregation is severe, the surface quality is deteriorated, hardness is increased, and the cold-rolled sheet is broken, thereby reducing rollability. Accordingly, Sn may be added in the above-mentioned range. Specifically, Sn may be included in an amount of 0.001 to 0.080 wt %. More specifically, Sn may be included in an amount of 0.010 to 0.080 wt %.

Sb: 0.080 wt % or less

Antimony (Sb) is segregated at the grain boundaries and the surfaces to improve the texture of the material and inhibit surface oxidation, and thus may be additionally added to improve the magnetism. When too much Sb is added, grain boundary segregation is severe, the surface quality is deteriorated, hardness is increased, and the cold-rolled sheet is broken, thereby reducing rollability. Accordingly, Sb may be added in the above-mentioned range. Specifically, Sb may be included in an amount of 0.001 to 0.080 wt %. More specifically, Sb may be included in an amount of 0.010 to 0.080 wt %.

The non-oriented electrical steel sheet according to the embodiment of the present invention may further include one or more of C: 0.01 wt % or less, S: 0.01 wt % or less, N: 0.01 wt % or less, and Ti: 0.005 wt % or less.

C: 0.0100 wt % or less

Carbon (C) is combined with Ti, Nb, etc. to form a carbide to degrade magnetism, and when used after processing from the final product to an electrical product, since iron loss increases due to magnetic aging to decreases efficiency of electrical equipment, an upper limit of an addition amount thereof may be made 0.0100 wt %. Specifically, C may be included in an amount of 0.0050 wt % or less. More specifically, C may be further included in an amount of 0.0001 to 0.0030 wt %.

S: 0.0100 wt % or less

Sulfur (S) forms fine sulfides inside the base material to suppress grain growth to weaken iron loss, so that it is desirable to add it as low as possible. When a large amount of S is included, it may be combined with Mn and the like to form precipitates or cause high-temperature brittleness during hot rolling. Accordingly, S may be included in an amount of 0.0100 wt % or less. Specifically, S may be included in an amount of 0.0050 wt % or less. More specifically, S may be further included in an amount of 0.0001 to 0.0030 wt %.

N: 0.0100 wt % or less

Nitrogen (N) not only forms fine long precipitates inside the base material by combining with Al, Ti, Nb, and the like, but also worsens iron loss such as inhibiting grain growth by combining with other impurities to form fine nitrides, so that it is preferable to be included in a small amount. In the embodiment of the present invention, N may be further included in an amount of 0.0100 wt % or less. Specifically, N may be further included in an amount of 0.0050 wt % or less. More specifically, N may be further included in an amount of 0.0001 to 0.0030 wt %.

Ti: 0.0050 wt % or leas

Titanium (Ti) is an element that has a very strong tendency to form precipitates in the steel, and forms fine carbides or nitrides inside the base material to inhibit grain growth, so that as more of it is added, more carbides and nitrides are formed, which deteriorates iron and makes magnetism inferior. In the embodiment of the present invention, Ti may be further included in an amount of 0.0050 wt % or less. Specifically, Ti may be further included in an amount of 0.0030 wt % or less. More specifically, Ti may be further included in an amount of 0.0005 to 0.0030 wt %.

The non-oriented electrical steel sheet according to the embodiment of the present invention may further include one or more of Cu, Ni, and Cr at 0.05 wt % or less, respectively.

Copper (Cu), nickel (Ni), and chromium (Cr), which are elements inevitably added in the steel making process, react with impurity elements to form fine sulfides, carbides, and nitrides to undesirably affect magnetism, so each of them is limited to 0.05 wt % or less.

The non-oriented electrical steel sheet according to the embodiment of the present invention may further include one or more of Zr, Mo, and V at 0.01 wt % or less, respectively.

Since zirconium (Zr), molybdenum (Mo), and vanadium (V) are strong carbonitride-forming elements, it is preferable to not be added as much as possible, and each of them should be included in an amount of 0.01 wt % or less.

Cu, Ni, and Cr, which are elements inevitably added in the steel making process, react with impurity elements to form fine sulfides, carbides, and nitrides to undesirably affect magnetism, so each of them is limited to 0.05 wt % or less. In addition, since Zr, Mo, V, etc. are also elements strongly forming carbonitrides, it is preferable that they are not added as much as possible, and they are contained in an amount of 0.01 wt % or less, respectively.

The balance includes Fe and inevitable impurities. The inevitable impurities are impurities mixed in the steel-making and the manufacturing process of the grain-oriented electrical steel sheet, which are widely known in the field, and thus a detailed description thereof will be omitted. In the embodiment of the present invention, the addition of elements other than the above-described alloy components is not excluded, and various elements may be included within a range that does not hinder the technical concept of the present invention. When the additional elements are further included, they replace the balance of Fe.

As described above, by appropriately controlling the addition amounts of Si, Mn, Al, Bi, and Ge, the texture may be improved by selectively forming and controlling the precipitates.

Specifically, when performing an EBSD test on a region of 1/6 to 1/4 of the thickness of the steel sheet, the intensity of {111}<112>on the ODF may be 2 or less compared to the random orientation. Magnetization of the non-oriented electrical steel sheet is most advantageous when a direction of a crystal plane is <100>based on a magnetization direction, and is advantageous in an order of <110>and <111>. Therefore, when a ratio of {111}<112>, which is an orientation that is unfavorable to the magnetization, is reduced, an orientation of grains configuring the steel sheet is configured in a direction that is favorable to the magnetization, thereby improving the magnetism. More specifically, the intensity of {111}<112>on the ODF may be 0.5 to 1.9 compared to the random orientation. The intensity of {111}<112>on the ODF may be 0.8 to 1.8 compared to the random orientation.

In addition, in the region of 1/6 to 1/4 of the thickness of the steel sheet, a ratio (V{100}/V{411}) of a fraction (V{100}) of the texture in which the {100}plane of the texture and the rolling plane are parallel within a 15° angle with respect to a fraction (V{411}) of the texture in which the {411} plane of the texture and the rolling plane are parallel within a 15° angle, may be 0.150 to 0.450.

In the region of 1/6 to 1/4 of the thickness of the steel sheet, a ratio (V{100}/V{411}) of a fraction (V{100}) of the texture in which the {100} plane of the texture and the rolling plane are parallel within a 10° angle with respect to a fraction (V{411}) of the texture in which the {411} plane of the texture and the rolling plane are parallel within a 10° angle, may be 0.350 to 0.550.

In the region of 1/6 to 1/4 of the thickness of the steel sheet, a ratio (V{100}/V{411}) of a fraction (V{100}) of the texture in which the {100} plane of the texture and the rolling plane are parallel within a 5° angle with respect to a fraction (V{411}) of the texture in which the {411} plane of the texture and the rolling plane are parallel within a 5° angle, may be 0.450 to 0.650.

The fraction (V{411}) of the texture in which the {411} plane and the rolling plane are parallel is formed in a large amount compared to the fraction (V{100}) of the texture in which the {100} plane and the rolling plane are parallel, so that it may contribute to magnetism enhancement.

As described above, by appropriately controlling the addition amounts of Si, Mn, Al, Bi, and Ge, it is possible to improve the magnetism by selectively forming and controlling the precipitates to improve the texture.

Specifically, the iron loss (W_{15/50}) of the electrical steel sheet may be 2.50 W/kg or less, and the magnetic flux density (B₅₀) thereof may be 1.67 T or more. The iron loss (W_{15/50}) is iron loss when a magnetic flux density of 1.5 T is induced at a frequency of 50 Hz. The magnetic flux density (B₅₀) is magnetic flux density induced in a magnetic field of 5000 Nm. Specifically, the iron loss (W_{15/50}) of the electrical steel sheet may be 2.40 W/kg or less, and the magnetic flux density (B₅₀) thereof may be 1.68 T or more. More specifically, the iron loss (W_{15/50}) of the electrical steel sheet may be 1.90 to 2.40 W/Kg, and the magnetic flux density (B₅₀) thereof may be 1.68 to 1.75 T. In this case, the magnetic measurement standard may be a thickness of 0.35 mm.

A manufacturing method of a non-oriented electrical steel sheet according to an embodiment of the present invention includes: hot-rolling a slab to manufacture a hot-rolled sheet; cold-rolling the hot-rolled sheet to manufacture a cold-rolled sheet; and final annealing the cold-rolled sheet.

The alloy components of the slab have been described in the alloy components of the above-described non-oriented electrical steel sheet, so duplicate descriptions thereof will be omitted. Since the alloy compositions are not substantially changed during the manufacturing process of the non-oriented electrical steel sheet, the alloy compositions of the non-oriented electrical steel sheet and the slab are substantially the same.

Specifically, the slab may include, in wt %, Si: 2.1 to 3.8%, Mn: 0.001 to 0.6%, Al: 0.001 to 0.6%, Bi: 0.0005 to 0.003%, and Ge: 0.0003 to 0.001%, and the balance of Fe and inevitable impurities.

Other additional elements of the slab have been described in the alloy components of the non-oriented electrical steel sheet, so duplicate descriptions thereof will be omitted.

The slab may be heated before hot-rolling the slab. The heating temperature of the slab is not limited, but the slab may be heated in a range of 1150 to 1250° C. for 0.1 to 1 hour. When the slab heating temperature is too high, precipitates such as AIN and MnS present in the slab are re-dissolved and then finely precipitated during hot-rolling and annealing, thereby inhibiting grain growth and reducing magnetism. Specifically, the slab may be heated in a range of 1100 to 1200° C. for 0.5 to 1 hour.

Next, the slab is hot-rolled to manufacture the hot-rolled sheet. A thickness of the hot-rolled sheet may be 1.6 to 2.3 mm. In the manufacturing of the hot-rolled sheet, a finish rolling temperature may be 800 to 1000° C. The hot-rolled sheet may be wound at temperatures of 700° C. or less.

After the manufacturing of the hot-rolled sheet, hot-rolled-sheet-annealing the hot-rolled sheet may be further included. In this case, a temperature of the hot-rolled-sheet-annealing may be 900 to 1195° C. The annealing time may be 30 to 95 seconds. When the temperature of the hot-rolled-sheet-annealing is too low, the structure does not grow or finely grows, making it difficult to obtain a magnetically beneficial texture during the annealing after the cold rolling. When the annealing temperature is too high, magnetic grains may excessively grow, and surface defects of the plate may become excessive. The hot-rolled sheet annealing is performed in order to increase the orientation favorable to magnetism as required, and it may be omitted. The annealed hot-rolled sheet may be pickled.

Next, the hot-rolled sheet is cold-rolled to manufacture a cold-rolled sheet. The cold-rolling is finally performed to a thickness of 0.10 mm to 0.35 mm. As necessary, the second cold-rolling after the first cold-rolling and the intermediate annealing may be performed, and the final rolling reduction may be in a range of 50 to 95%.

Next, the cold-rolled sheet is finally annealed. In the process of annealing the cold-rolled sheet, the annealing temperature is not largely limited as long as it is a temperature generally applied to the non-oriented electrical steel sheet. Since the iron loss of the non-oriented electrical steel sheet is closely related to the grain size, it may be annealed at 850 to 1080° C. for 60 to 150 seconds. When the temperature is too low, the hysteresis loss increases because the grains are too fine, and when the temperature is too high, the grains are too coarse and thus the eddy current loss increases, so that the iron loss is deteriorated. Specifically, the annealing may be performed at a temperature of 900 to 1060° C. for 60 to 120 seconds.

After final annealing, an average grain diameter of the steel sheet may be 70 to 150 pm, and all (99% or more) of the processed structure may be recrystallized by cold rolling.

After the final annealing, an insulating film may be formed. The insulating film may be formed as an organic, inorganic, and organic/inorganic composite film, and it may be formed with other insulating coating materials.

Hereinafter, the present invention will be described in more detail through examples. However, the examples are only for illustrating the present invention, and the present invention is not limited thereto.

### EXAMPLE

Slabs including the alloy compositions and the balance of Fe and inevitable impurities summarized in Table 1 and Table 2 below were manufactured. The slab was heated at 1150° C., hot-rolled, and then wound. The wound and cooled hot-rolled steel sheet was annealed and pickled at the temperatures shown in Table 2 below, then cold-rolled to the thicknesses shown in Table 2, and finally cold-rolled sheet annealed. In this case, the annealing temperatures are summarized in Table 2.

The manufactured final annealed sheet was formed as an Epstein specimen with a length of 305 mm and a width of 30 mm for magnetic measurement from an L direction (rolling direction) and a C direction (rolling vertical direction), and the iron loss (W_{15/50}) and magnetic flux density (B₅₀) were measured, and the results are shown in Table 3 below.

In addition, in order to measure the texture, a 5 mm×5 mm area thereof was observed by using EBSD. The texture characteristics were obtained based on the observed data, and the results are shown in Table 3 below.

The Iron loss (W_{15/50}) is average loss (W/kg) of the rolling direction and the transverse direction when the magnetic flux density of 1.5 Tesla is induced at a frequency of 50 Hz.

The magnetic flux density (B₅₀) is a magnetic flux density (Tesla) induced when a magnetic field of 5000 A/m is applied.

TABLE 1

| Example | Si | Mn | Al | P | C | S | N | Ti | Sn | Sb |
|---|---|---|---|---|---|---|---|---|---|---|
| Comparative | 3.69 | 0.33 | 0.56 | 0.005 | 0.0015 | 0.0007 | 0.0015 | 0.0007 | 0.05 | 0.01 |
| Material 1 | | | | | | | | | | |
| Comparative | 3.45 | 0.02 | 0.25 | 0.001 | 0.0013 | 0.0015 | 0.0021 | 0.0012 | 0.04 | 0.01 |
| Material 2 | | | | | | | | | | |
| Comparative | 3.02 | 0.47 | 0.07 | 0.007 | 0.0007 | 0.0030 | 0.0024 | 0.0009 | 0.04 | 0.01 |
| Material 3 | | | | | | | | | | |
| Comparative | 2.86 | 0.05 | 0.12 | 0.010 | 0.0021 | 0.0021 | 0.0008 | 0.0013 | 0.01 | 0.03 |
| Material 4 | | | | | | | | | | |
| Inventive | 3.12 | 0.01 | 0.01 | 0.004 | 0.0025 | 0.0018 | 0.0013 | 0.0015 | 0.05 | 0.01 |
| Material 1 | | | | | | | | | | |
| Inventive | 2.95 | 0.03 | 0.21 | 0.001 | 0.0005 | 0.0010 | 0.0014 | 0.0010 | 0.02 | 0.02 |
| Material 2 | | | | | | | | | | |
| Inventive | 2.69 | 0.15 | 0.13 | 0.001 | 0.0014 | 0.0009 | 0.0027 | 0.0008 | 0.04 | 0.03 |
| Material 3 | | | | | | | | | | |
| Inventive | 2.61 | 0.27 | 0.05 | 0.002 | 0.0027 | 0.0014 | 0.0019 | 0.0008 | 0.04 | 0.01 |
| Material 4 | | | | | | | | | | |
| Inventive | 3.05 | 0.22 | 0.30 | 0.008 | 0.0008 | 0.0017 | 0.0017 | 0.0004 | 0.06 | 0.06 |
| Material 5 | | | | | | | | | | |
| Inventive | 2.71 | 0.22 | 0.27 | 0.003 | 0.0013 | 0.0008 | 0.0005 | 0.0020 | 0.04 | 0.01 |
| Material 6 | | | | | | | | | | |
| Inventive | 2.15 | 0.05 | 0.07 | 0.010 | 0.0011 | 0.0025 | 0.0009 | 0.0016 | 0.07 | 0.02 |
| Material 7 | | | | | | | | | | |
| Inventive | 3.06 | 0.41 | 0.50 | 0.009 | 0.0020 | 0.0012 | 0.0026 | 0.0016 | 0.03 | 0.07 |
| Material 8 | | | | | | | | | | |
| Inventive | 2.51 | 0.56 | 0.24 | 0.007 | 0.0016 | 0.0004 | 0.0007 | 0.0014 | 0.02 | 0.08 |
| Material 9 | | | | | | | | | | |
| Inventive | 3.03 | 0.08 | 0.01 | 0.007 | 0.0022 | 0.0013 | 0.0026 | 0.0005 | 0.01 | 0.04 |
| Material 10 | | | | | | | | | | |
| Inventive | 3.10 | 0.46 | 0.57 | 0.005 | 0.0004 | 0.0016 | 0.0006 | 0.0006 | 0.08 | 0.02 |
| Material 11 | | | | | | | | | | |

TABLE 2

| | | | | Hot-rolled | Hot-rolled | | |
|---|---|---|---|---|---|---|---|
| | | | | plate | plate | Final | |
| | | | | annealing | annealing | annealing | Final |
| | | | Thickness | temperature | time | temperature | annealing |
| Example | Bi | Ge | (μm) | (° C.) | (s) | (° C.) | time (s) |
| Comparative | 0.0001 | 0.0003 | 0.27 | 900 | 80 | 1040 | 120 |
| Material 1 | | | | | | | |
| Comparative | 0.0015 | 0.0001 | 0.3 | 930 | 80 | 1000 | 100 |
| Material 2 | | | | | | | |
| Comparative | 0.0044 | 0.0008 | 0.3 | 950 | 80 | 980 | 80 |
| Material 3 | | | | | | | |
| Comparative | 0.0025 | 0.0014 | 0.35 | 970 | 50 | 1020 | 120 |
| Material 4 | | | | | | | |
| Inventive | 0.0005 | 0.0007 | 0.27 | 930 | 80 | 1040 | 100 |
| Material 1 | | | | | | | |
| Inventive | 0.0013 | 0.0008 | 0.27 | 930 | 60 | 1000 | 120 |
| Material 2 | | | | | | | |
| Inventive | 0.0010 | 0.0008 | 0.27 | 950 | 60 | 980 | 120 |
| Material 3 | | | | | | | |
| Inventive | 0.0021 | 0.0010 | 0.3 | 920 | 80 | 960 | 50 |
| Material 4 | | | | | | | |
| Inventive | 0.0026 | 0.0005 | 0.3 | 920 | 80 | 1020 | 120 |
| Material 5 | | | | | | | |
| Inventive | 0.0008 | 0.0006 | 0.3 | 950 | 70 | 1040 | 120 |
| Material 6 | | | | | | | |
| Inventive | 0.0016 | 0.0006 | 0.3 | 970 | 60 | 1040 | 70 |
| Material 7 | | | | | | | |
| Inventive | 0.0016 | 0.0005 | 0.35 | 990 | 40 | 980 | 70 |
| Material 8 | | | | | | | |
| Inventive | 0.0012 | 0.0009 | 0.35 | 980 | 40 | 990 | 100 |
| Material 9 | | | | | | | |
| Inventive | 0.0025 | 0.0008 | 0.35 | 950 | 60 | 950 | 100 |
| Material 10 | | | | | | | |
| Inventive | 0.0023 | 0.0010 | 0.35 | 950 | 60 | 950 | 80 |
| Material 11 | | | | | | | |

TABLE 3

| | | V{001}/ | | | Iron | Magnetic |
|---|---|---|---|---|---|---|
| | | V{411} | V{001}/V{411} | V{001}/V{411} | loss | flux |
| | | at 15 degrees | at 10 degrees | at 5 degrees | (W15/ | density |
| | I{111} < | V{001}/ | V{001}/ | V{001}/ | 50, | (B50, |
| Example | 112> | V{411} | V{411} | V{411} | W/kg) | T) |
| Comparative | 2.2 | 0.06 | 0.253 | 0.382 | 2.05 | 1.64 |
| Material 1 | | | | | | |
| Comparative | 1.5 | 0.101 | 0.318 | 0.451 | 2.3 | 1.65 |
| Material 2 | | | | | | |
| Comparative | 1.8 | 0.172 | 0.412 | 0.446 | 2.28 | 1.65 |
| Material 3 | | | | | | |
| Comparative | 1.5 | 0.01 | 0.129 | 0.217 | 2.61 | 1.65 |
| Material 4 | | | | | | |
| Inventive | 1.6 | 0.152 | 0.386 | 0.554 | 2.41 | 1.71 |
| Material 1 | | | | | | |
| Inventive | 1.4 | 0.193 | 0.501 | 0.612 | 2.27 | 1.71 |
| Material 2 | | | | | | |
| Inventive | 1.5 | 0.178 | 0.36 | 0.535 | 2.39 | 1.73 |
| Material 3 | | | | | | |
| Inventive | 1.8 | 0.294 | 0.519 | 0.645 | 2.23 | 1.72 |
| Material 4 | | | | | | |
| Inventive | 0.9 | 0.268 | 0.413 | 0.602 | 1.95 | 1.7 |
| Material 5 | | | | | | |
| Inventive | 1.1 | 0.345 | 0.479 | 0.514 | 1.92 | 1.7 |
| Material 6 | | | | | | |
| Inventive | 1.3 | 0.32 | 0.445 | 0.646 | 2.31 | 1.74 |
| Material 7 | | | | | | |
| Inventive | 1.4 | 0.279 | 0.439 | 0.534 | 2.18 | 1.69 |
| Material 8 | | | | | | |
| Inventive | 1.4 | 0.162 | 0.363 | 0.607 | 2.33 | 1.72 |
| Material 9 | | | | | | |
| Inventive | 0.8 | 0.207 | 0.422 | 0.511 | 2.36 | 1.71 |
| Material 10 | | | | | | |
| Inventive | 1.2 | 0.23 | 0.411 | 0.559 | 2.15 | 1.68 |
| Material 11 | | | | | | |

As shown in Table 1 to Table 3, Inventive Material 1 to Inventive Material 11, in which Si, Al, Mn, Bi, and Ge satisfied respective component addition ranges, had the improved texture, and showed the excellent iron loss W_{15/50} and magnetic flux density B50.

On the other hand, it can be confirmed that Comparative Example 1 included too little Bi, so the texture was not improved and the magnetism was inferior.

It can be confirmed that Comparative Example 2 included too little Ge, so the texture was not improved and the magnetism was inferior.

It can be confirmed that Comparative Example 3 included an excess of Bi, so the texture was not improved and the magnetism was inferior.

It can be confirmed that Comparative Example 4 included an excess of Ge, so the texture was not improved and the magnetism was inferior.

The present invention may be embodied in many different forms, and should not be construed as being limited to the disclosed embodiments. In addition, it will be understood by those skilled in the art that various changes in form and details may be made thereto without departing from the technical spirit and essential features of the present invention. Therefore, it is to be understood that the above-described embodiments are for illustrative purposes only, and the scope of the present invention is not limited thereto.

1. A non-oriented electrical steel sheet including, in wt %, Si: 2.1 to 3.8%, Mn: 0.001 to 0.6%, Al: 0.001 to 0.6%, Bi: 0.0005 to 0.003%, and Ge: 0.0003 to 0.001%, and the balance of Fe and inevitable impurities.

2. The non-oriented electrical steel sheet of claim 1, further comprising
one or more of P: 0.08 wt % or less, Sn: 0.08 wt % or less, and Sb: 0.08 wt % or less.

3. The non-oriented electrical steel sheet of claim 1, further comprising
one or more of C: 0.01 wt % or less, S: 0.01 wt % or less, N: 0.01 wt % or less, and Ti: 0.005 wt % or less.

4. The non-oriented electrical steel sheet of claim 1, wherein
one or more of Cu, Ni, and Cr are further included in an amount of 0.05 wt % or less, respectively.

5. The non-oriented electrical steel sheet of claim 1, wherein
one or more of Zr, Mo, and V are further included in an amount of 0.01 wt % or less, respectively.

6. The non-oriented electrical steel sheet of claim 1, wherein
when an EBSD test is performed on a 1/6 to 1/4 region of a thickness of the steel sheet, a strength of a {111} plane facing a <112>direction based on a rolling direction on an ODF is 2 or less compared to a random orientation.

7. The non-oriented electrical steel sheet of claim 1, wherein
in a region of 1/6 to 1/4 of a thickness of the steel sheet, a ratio (V{100}/V{411}) of a fraction (V{100}) of texture in which a {100} plane of the texture and a rolling plane are parallel within a 15° angle with respect to a fraction (V{411}) of the texture in which a {411} plane of the texture and the rolling plane are parallel within a 15° angle, is 0.150 to 0.450.

8. The non-oriented electrical steel sheet of claim 1, wherein in a region of 1/6 to 1/4 of a thickness of the steel sheet, a ratio (V{100}/V{411}) of a fraction (V{100}) of texture in which a {100} plane of the texture and a rolling plane are parallel within a 10° angle with respect to a fraction (V{411}) of the texture in which a {411} plane of the texture and the rolling plane are parallel within a 10° angle, is 0.350 to 0.550.

9. The non-oriented electrical steel sheet of claim 1, wherein
in a region of 1/6 to 1/4 of a thickness of the steel sheet, a ratio (V{100}/V{411}) of a fraction (V{100}) of texture in which a {100} plane of the texture and a rolling plane are parallel within a 5° angle with respect to a fraction (V{411}) of the texture in which a {411} plane of the texture and the rolling plane are parallel within a 5° angle, is 0.450 to 0.650.

10. A manufacturing method of a non-oriented electrical steel sheet, comprising:
hot-rolling a slab that includes, in wt %, Si: 2.1 to 3.8%, Mn: 0.001 to 0.6%, Al: 0.001 to 0.6%, Bi: 0.0005 to 0.003%, and Ge: 0.0003 to 0.001%, the balance of Fe, and inevitable impurities to manufacture a hot-rolled sheet;
cold-rolling the hot-rolled sheet to manufacture a cold-rolled sheet; and
final annealing the cold-rolled sheet.

11. The manufacturing method of the non-oriented electrical steel sheet of claim 10, further comprising
after the manufacturing of the hot-rolled sheet, annealing the hot-rolled sheet at a temperature of 900 to 1195° C. for 30 to 95 seconds.

12. The manufacturing method of the non-oriented electrical steel sheet of claim 10, wherein
the final annealing is performed at a temperature of 850 to 1080° C. for 60 to 150 seconds.
